(19) United States
(12) Patent Application Publication
(10) Pub. No.: US 2025/0306365 A1
(43) Pub. Date: Oct. 2, 2025

(54) HEAD-UP DISPLAY

(71) Applicant: Panasonic Automotive Systems Co., Ltd., Kanagawa (JP)

(72) Inventor: Tomoaki MIYAMOTO, Osaka (JP)

(73) Assignee: Panasonic Automotive Systems Co., Ltd., Kanagawa (JP)

(21) Appl. No.: 19/081,863

(22) Filed: Mar. 17, 2025

(30) Foreign Application Priority Data
Mar. 26, 2024 (JP) 2024-049793

(51) Int. Cl. G02B 27/01

(52) U.S. Cl. CPC G02B 27/0101; G02B 2027/011

(57) ABSTRACT

A head-up display includes an image generation and a projection optical system. The projection optical system includes a first mirror that has power and is closest to the image generation device. The first mirror is asymmetrical in shape relative to a first Y-axis. A length of a first X-axis component of a point A vector NA and a length of a first X-axis component of a point B vector NB are identical. The point A vector is a normal vector of a length L1 at a point A that is a predetermined point. The point B vector is a normal vector of the length L1 at a point B that is another point having a Y-axis value identical to a Y-axis value of the point A and an X-axis value that is an inversely signed number with a magnitude identical to an X-axis value of the point A.

### CROSS REFERENCE TO RELATED APPLICATION

The present application is based on and claims priority of Japanese Patent Application No. 2024-049793 filed on Mar. 26, 2024.

### FIELD

The present disclosure relates to a head-up display that allows an observer to view an image being displayed as a virtual image.

### BACKGROUND

Patent Literature (PTL) 1 describes a head-up display that is compact and can be provided in an automobile or the like.

### CITATION LIST

### Patent Literature

PTL 1: Japanese Patent No. 6857800

### SUMMARY

However, head-up display according to the above-mentioned PTL 1 can be improved upon.

In view of this, in the present disclosure, a head-up display that can further improve upon the related art is provided.

A head-up display according to the present disclosure is a head-up display that projects an image onto an object capable of at least reflecting light, and forms a virtual image that is visible to an observer, in a virtual image region virtually generated on one side of the object relative to the observer, and the head-up display includes: an image generation device that projects the image; and a projection optical system that guides the image projected from the image generation device to the object, and forms the virtual image, wherein the projection optical system includes a first mirror that has power and is closest to the image generation device in order on a light path along which the image generation device projects the image, when (i) a light beam that passes through a center of the virtual image region is a gut ray, (ii) a point of reflection of the gut ray is a first origin, (iii) a normal line of the first mirror at the first origin is a first Z-axis, (iv) an axis that is orthogonal to the first Z-axis and corresponds to a left-and-right direction of the virtual image is a first X-axis, and (v) an axis that is orthogonal to the first Z-axis and the first X-axis is a first Y-axis, the first mirror is asymmetrical in shape relative to the first Y-axis, and a length of a first X-axis component of a point A vector and a length of a first X-axis component of a point B vector are identical or approximately identical, the point A vector being a normal vector of a length L1 at a point A that is a predetermined point on the first mirror, the point B vector being a normal vector of the length L1 at a point B that is an other point having a Y-axis value identical to a Y-axis value of the point A and an X-axis value that is an inversely signed number with a magnitude identical to an X-axis value of the point A.

The head-up display according to one aspect of the present disclosure can further improve upon the related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a diagram illustrating a cross section of a vehicle in which a head-up display is provided.

FIG. 2 is a perspective view of a first mirror and an image generation device.

FIG. 3 is a cross-sectional view of a state in which the first mirror is cut along a first XZ plane at a first origin.

FIG. 4 is a perspective view of a display component viewed from a projection side.

FIG. 5 is a plan view of the display component viewed from a second Y-axis direction.

FIG. 6 is a diagram illustrating a cross section of a vehicle in which another example of a head-up display is provided.

FIG. 7 is a plan view that comparatively illustrates a right-hand drive vehicle and a left-hand drive vehicle in which the head-up display is provided.

### DESCRIPTION OF EMBODIMENT

Hereinafter, an embodiment of a head-up display according to the present disclosure will be described with reference to the drawings. It should be noted that the following embodiment is merely an example for describing the present disclosure, and is not intended to limit the scope of the present disclosure. For example, the shapes, structures, materials, elements, relative positional relationships, connection states, numerical values, formulas, and details of each of the steps and the order of the steps of the methods, and the like, described in the following embodiment are mere examples, and may include details that are not included in the following descriptions. Furthermore, although geometric expressions, such as “parallel” and “orthogonal”, may be used, these expressions are not mathematically precise indications and include substantially permissible error, deviation, and the like. Moreover, expressions, such as “simultaneous” and “identical (or the same)”, are considered to cover a substantially permissible range of meaning.

Additionally, the drawings are schematic illustrations, which may include emphasis, omission, or adjustment of proportion as necessary for the purpose of illustrating the present disclosure, and thus the shapes, positional relationships, and proportions shown may be different from actuality. Furthermore, an X-axis, Y-axis, and Z-axis, which may be shown in the figures indicate orthogonal coordinates that have been set in an arbitrary manner for the purpose of describing the figures. That is to say, a Z-axis is not necessarily an axis that extends in a vertical direction, and X and Y axes do not necessarily lie within a horizontal plane.

Furthermore, hereinafter, multiple aspects may be comprehensively described as a single embodiment. Moreover, part of the contents in the description below describes optional elements related to the present disclosure.

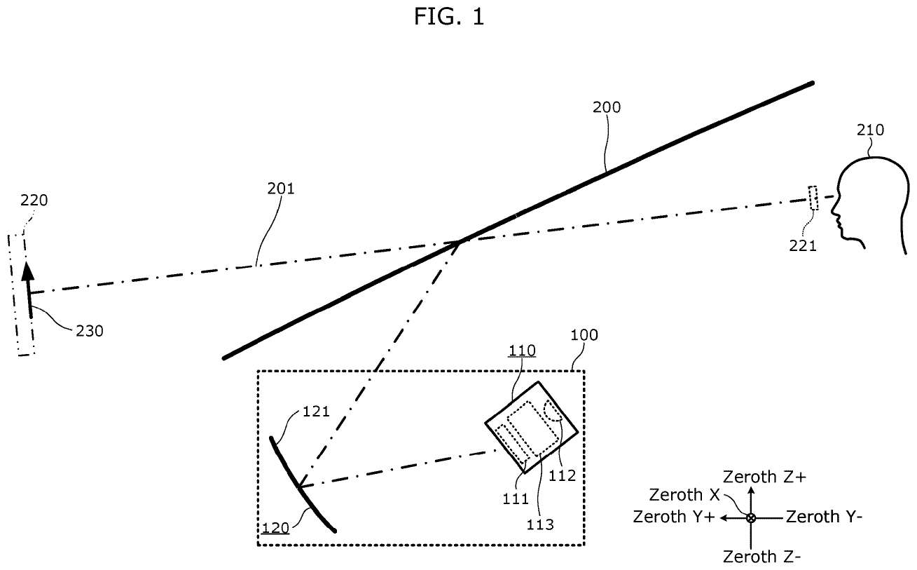

FIG. 1 is a diagram illustrating a cross section of a vehicle in which head-up display 100 is provided. It should be noted that in the coordinate axes illustrated in FIG. 1, a zeroth X-axis, zeroth Y-axis, and zeroth Z-axis are tentatively defined as respectively representing a widthwise direction, a front-and-back direction, and an up-and-down direction of the vehicle itself, and such axes do not necessarily coincide with the individual axes that are defined for each of the components described later.

Head-up display 100 is a device that projects an image formed by light projected onto object 200 that is at least capable of reflecting light, and virtually forms virtual image 230 that is visible to observer 210, in virtual image region 220 that is virtually generated on one side of object 200 relative to observer 210. Head-up display 100 includes image generation device 110 and projection optical system 120. The target object in which head-up display 100 is installed is not particularly limited, and examples include vehicles, such as automobiles, buses, and trucks.

Note that in the present embodiment, virtual image 230 is formed on the other side of object 200 relative to observer 210. Furthermore, gut ray 201 passes through the center of eye box 221. Eye box 221 is a region that includes an eye point and which is assumed in advance to be a spatial region in which virtual image 230 can be viewed by observer 210 while observer 210 is seated in the driver seat and driving.

Object 200 is not particularly limited as long as it is a component that is capable of reflecting light. In the present embodiment, object 200 is a windshield (windproof glass) that is disposed in front of observer 210 (driver) in the vehicle cabin, and is a component on which the image projected by image generation device 110 is displayed. Head-up display 100 is disposed on a vehicle component, such as a dashboard of a vehicle, and projects the image from inside the vehicle cabin onto object 200. Accordingly, virtual image 230 is formed in virtual image region 220 that is on a side of object 200 opposite of observer 210 (outside vehicle cabin). Observer 210 can view both the scenery that is visible through object 200 and virtual image 230 that are overlaid on each other. The dash-dotted line shown in FIG. 1 illustrates gut ray 201 that is a light beam that passes through the center of virtual image region 220 that is the region in which virtual image 230 that is visible to observer 210, can be formed. It should be noted that the position of gut ray 201 is not clearly defined, and may change depending on the size, posture, seat position, and the like of observer 210.

Projection optical system 120 is a device that guides the image projected from image generation device 110 to object 200, and includes a single optical element or a plurality of optical elements designed to form virtual image 230 by using object 200. Although the optical elements included in projection optical system 120 are not particularly limited, projection optical system 120 includes at least first mirror 121 as an optical element that has power and is closest to image generation device 110 in order on a light path across which image generation device 110 projects the image. In other words, there are no optical elements that have power that contribute to the projection of the image disposed between first mirror 121 and image generation device 110. Furthermore, an optical element that has no power may be disposed between first mirror 121 and image generation device 110.

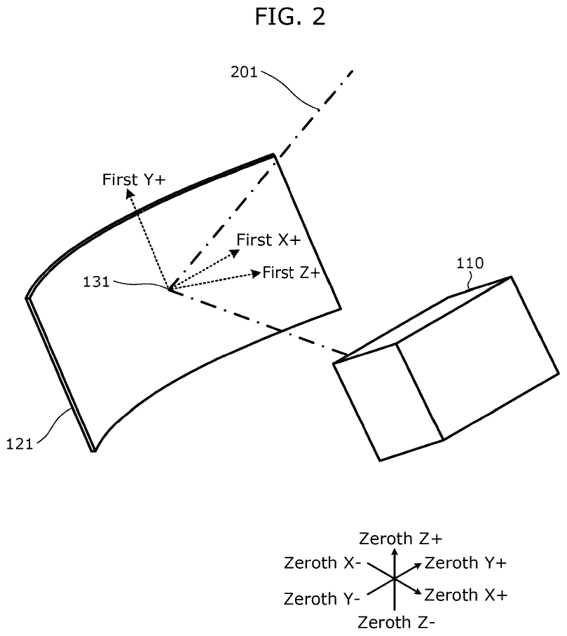

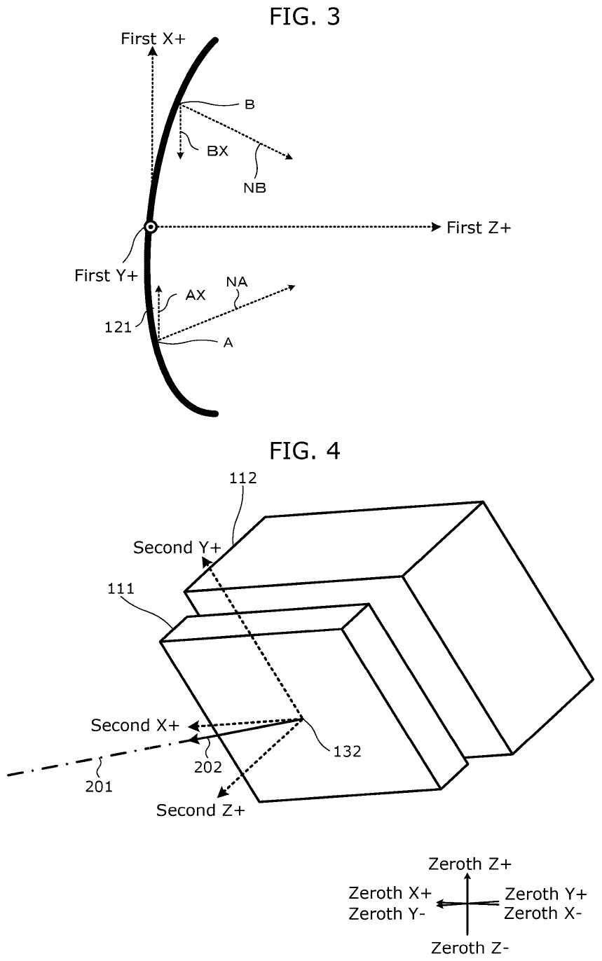

FIG. 2 is a perspective view of first mirror 121 and image generation device 110. FIG. 3 is a cross-sectional view of a state in which first mirror 121 is cut along a first XZ plane at first origin 131. It should be noted that the shape of first mirror 121 illustrated in FIG. 2 and FIG. 3 does not reflect the actual shape of first mirror 121, and is merely a schematic illustration for descriptive purposes. In first mirror 121, when a point of reflection of gut ray 201 is first origin 131, a normal line of first mirror 121 at first origin 131 is a first Z-axis, an axis that is orthogonal to the first Z-axis and corresponds to a left-and-right direction of virtual image 230 is a first X-axis, and an axis that is orthogonal to the first Z-axis and the first X-axis is a first Y-axis, first mirror 121 is asymmetrical in shape relative to the first Y-axis. When the first YZ plane is the plane of symmetry, first mirror 121 has an overall shape that is asymmetrical.

Furthermore, as illustrated in FIG. 3, a normal vector of length L1 at an arbitrarily determined point A on first mirror 121 is point A vector NA. A normal vector of length L1 at point B, which has a Y-axis value in the first Y-axis that is identical to a Y-axis value in the first Y-axis of point A, and an X-axis value that is an inversely signed number with a magnitude identical to an X-axis value of point A, is point B vector NB. Note that in FIG. 3, although the length of point A vector NA and the length of point B vector NB appear different from each other (the length of point B vector NB is shorter than the length of point A vector NA), this is because each of these normal vectors are tilted in a three-dimensional manner and are being projected onto the first XZ plane. In other words, at least one of point A vector NA or point B vector NB is tilted toward the first Y-axis. The length of vector AX, which is a first X-axis component of point A vector NA, and the length of vector BX, which is a first X-axis component of point B vector NB, are identical or approximately identical.

In the present embodiment, the shape of first mirror 121 satisfies Expression 1 shown below.

$$\vert \vert AX \vert - \vert BX \vert \vert \leq 0.1 \times L 1 ( “ \leq ” indicates “ less than or equal to ” and “ x ” indicates “ multiplication ” ) \qquad ( Expression 1 )$$

In the present embodiment, vector AX and vector BX “having lengths that are approximately identical” refers to a state in which the difference between the two lengths is no more than 10 percent of length L1 of the normal vector.

Furthermore, first mirror 121 is also asymmetrical in shape relative to the first X-axis. When the first XZ plane is the plane of symmetry, first mirror 121 has an overall shape that is asymmetrical.

Image generation device 110 is a device that forms an image that corresponds to virtual image 230, and projects the image onto object 200 via projection optical system 120, and is a projector referred to as a picture generation unit (PGU) or the like. In the present embodiment, image generation device 110 includes display component 111, light source 112, and lighting optical system 113.

FIG. 4 is a perspective view of display component 111 viewed from a projection side. Display component 111 is a component that forms an image corresponding to virtual image 230. Although display component 111 is not particularly limited, examples of display component 111 include a case where image generation device 110 involves a thin film transistor liquid crystal (TFT LC) method, i.e., a liquid crystal panel that includes liquid crystals arranged in a matrix or the like, and a case where image generation device 110 is a digital micro-mirror device (DMD), i.e., a semiconductor panel or the like on which a large number of movable microscopic mirror surfaces (micro-mirrors) have been integrated. It should be noted that a diffusion panel that diffuses laser light for forming an image suitable for virtual image 230 may be included as display component 111.

In the present embodiment, in display component 111, when a point (includes a point of reflection when display component 111 is a mirror) at which gut ray 201 passes through is second origin 132, a normal line of display component 111 at second origin 132 is a second Z-axis, an axis that is orthogonal to the second Z-axis and corresponds to a left-and-right direction of virtual image 230 is a second X-axis, and an axis that is orthogonal to the second Z-axis and the second X-axis is a second Y-axis, a second X-axis component of gut ray vector 202, which is located on gut ray 201 and is of a predetermined length, is either zero or a minute value. In other words, gut ray 201 approximately passes through the inside of the second YZ plane, and at least one of a second Y-axis component or a second Z-axis component of gut ray 201 is dominant in the generation of virtual image 230. Specifically, Expression 2 shown below may be satisfied.

$$\vert Length of second X - axis component of gut ray vector 202 / Length of second Z - axis component of gut ray vector 202 \vert < 0.3 \qquad ( Expression 2 )$$

When Expression 2 is not satisfied, unevenness of brightness will become 30 percent or less, thereby causing unevenness of the virtual image viewed by observer 210 to become noticeable.

Light source 112 is a device that generates light that is projected as an image onto object 200. Although light source 112 is not particularly limited, examples include a light emitting diode (LED), a laser diode (LD), or the like.

Lighting optical system 113 is a device that includes a single optical element or a plurality of optical elements designed such that light emitted by light source 112 includes light beams (parallel light, for example) appropriate for forming virtual image 230. The optical element is not particularly limited, and examples include a convex lens, concave lens, Fresnel lens, prism, convex mirror, concave mirror, or the like. In the present embodiment, image generation device 110 includes, as an optical element included in lighting optical system 113, a lighting lens that is bilaterally symmetrical in shape (symmetrically shaped relative to the second Y-axis) in a left-and-right direction (second X-axis direction illustrated in FIG. 4) that corresponds to the left-and-right direction of virtual image 230.

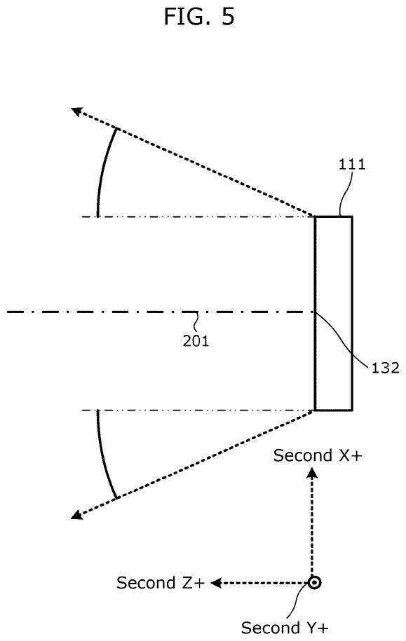

Furthermore, when an image is projected onto object 200 such that a white-colored virtual image 230 spreads out across the entirety of virtual image region 220, for example, angles relative to gut ray 201 of the white light projected from display component 111 are bilaterally symmetrical or approximately bilaterally symmetrical relative to the second Y-axis, as illustrated in FIG. 5. In other words, plane symmetry or approximate plane symmetry relative to the second YZ plane can be observed for brightness at each point of the white light on the surface orthogonal to gut ray 201.

Moreover, the present disclosure is not limited to the above-mentioned embodiment. For example, other embodiments produced by arbitrarily combining or omitting some elements described in the present Description may be included as embodiments of the present disclosure. Moreover, the present disclosure includes variations obtained by various modifications to the above embodiment that can be conceived by those skilled in the art, so long as they do not depart from the essence of the present disclosure, that is, the intended meaning of the appended Claims.

In the above embodiment, although a projection optical system 120 including only a first mirror 121 that has power is described as an example, projection optical system 120 may include a single optical element or a plurality of optical elements that have no power in addition to the first mirror 121 that has power.

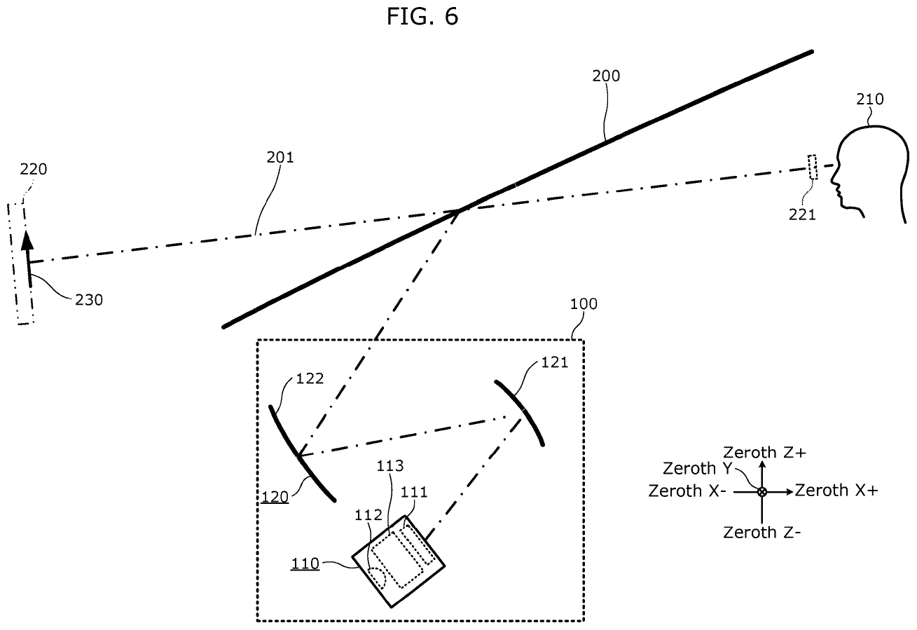

Furthermore, as illustrated in FIG. 6, projection optical system 120 may include second mirror 122 that has power. Even in this case, the very first optical element that has power that the light beam reaches as it travels along the path of the gut ray projected from image generation device 110 is first mirror 121.

Furthermore, in the present embodiment, although an example was described, in the coordinate system based on the vehicle, in which the zeroth X-axis that is the widthwise direction of the vehicle is parallel to the second X-axis of display component 111, these axes need not be parallel. Image generation device 110 may be disposed in an arbitrary direction, and the second X-axis and the zeroth Y-axis may be parallel, for example.

Furthermore, the first Z-axis is a normal line of first mirror 121 at a point at which gut ray 201 passes through or is reflected, the second Z-axis is a normal line of display component 111 at a point at which gut ray 201 passes through or is reflected, and the first Z-axis and the second Z-axis are determined by the arrangement and orientation of first mirror 121 in projection optical system 120 and the arrangement and orientation of image generation device 110.

### SUMMARY

Head-up display 100 according to a first aspect is a head-up display that projects an image onto object 200 capable of transmitting or reflecting light, and forms virtual image 230 that is visible to observer 210, in virtual image region 220 virtually generated on one side of object 200 relative to observer 210, and head-up display 100 includes: image generation device 110 that projects the image; and projection optical system 120 that guides the image projected from image generation device 110 to object 200, and forms virtual image 230. Projection optical system 120 includes first mirror 121 that has power and is closest to image generation device 110 in order on a light path along which image generation device 110 projects the image. When (i) a light beam that passes through a center of virtual image region 220 is gut ray 201, (ii) a point of reflection of gut ray 201 is first origin 131, (iii) a normal line of first mirror 121 at first origin 131 is a first Z-axis, (iv) an axis that is orthogonal to the first Z-axis and corresponds to a left-and-right direction of virtual image 230 is a first X-axis, and (v) an axis that is orthogonal to the first Z-axis and the first X-axis is a first Y-axis, first mirror 121 is asymmetrical in shape relative to the first Y-axis. A length of a first X-axis component of a point A vector NA and a length of a first X-axis component of a point B vector are identical or approximately identical, the point A vector being a normal vector of a length L1 at a point A that is a predetermined point on first mirror 121, the point B vector being a normal vector of the length L1 at a point B that is an other point having a Y-axis value identical to a Y-axis value of the point A and an X-axis value that is an inversely signed number with a magnitude identical to an X-axis value of the point A.

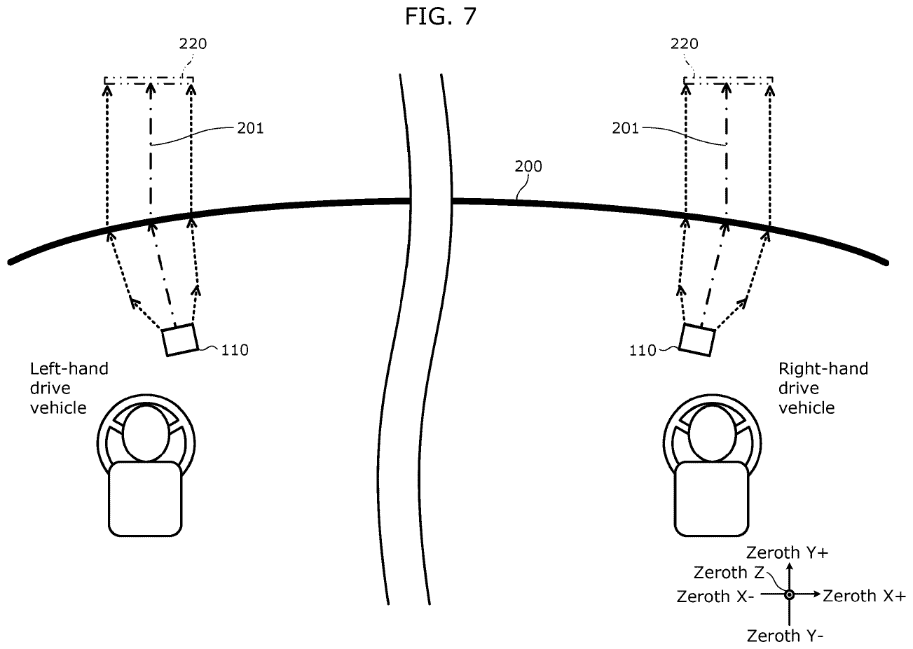

According to the first aspect, as illustrated in FIG. 7, projection optical systems 120 of an identical design (in terms of shape of each optical element and distance between neighboring optical elements; note that individual optical elements are arranged in mirror symmetry) and image generation devices 110 of the same type, can be used in both a case where virtual image 230 is formed by projecting an image onto an object 200 on a right side (positive side of zeroth X-axis) of a vehicle, and a case where virtual image 230 is formed by projecting an image onto an object 200 on a left side (negative side of zeroth X-axis) of a vehicle, thereby making it possible to form the same virtual image 230 in either case.

Head-up display 100 according to a second aspect is head-up display 100 according to the first aspect, in which image generation device 110 includes display component 111 that displays the image. When (i) a point at which gut ray 201 passes through is second origin 132, (ii) a normal line of display component 111 at second origin 132 is a second Z-axis, (iii) an axis of display component 111 that is orthogonal to the second Z-axis and corresponds to the left-and-right direction of virtual image 230 is a second X-axis, and (iv) an axis that is orthogonal to the second Z-axis and the second X-axis is a second Y-axis, in display component 111, a second X-axis component of a vector of gut ray 201 is either zero or a minute value, the vector of gut ray 201 being located on gut ray 201 and being of a predetermined length.

According to the second aspect, unevenness of brightness at least in the left-and-right direction of virtual image 230 can be reduced.

Head-up display 100 according to a third aspect is head-up display 100 according to the first aspect or the second aspect, in which, when the first X-axis component of the point A vector NA is AX and the first X-axis component of the point B vector is BX, ∥AX|−|BX∥≤0.1×L1 is satisfied.

According to the third aspect, distortion of virtual image 230 can be reduced to a degree to which observer 210 does not experience a sense of unnaturalness.

Head-up display 100 according to a fourth aspect is head-up display 100 according to any one of the first to third aspects, in which first mirror 121 is asymmetrical in shape relative to the first X-axis.

According to the fourth aspect, it is possible to properly accommodate the shape of object 200.

Head-up display 100 according to a fifth aspect is head-up display 100 according to any one of the first to fourth aspects, in which, in projection optical system 120, only first mirror 121 has power.

According to the fifth aspect, head-up display 100 can be miniaturized. Furthermore, in projection optical system 120 that includes a convex mirror and a concave mirror, which is a so-called telephoto type of projection optical system 120, although it is difficult to achieve both miniaturization and an increase in the screen size of virtual image region 220 due to interference between the optical elements and light, according to the fifth aspect, it becomes relatively easier to achieve both miniaturization and an increase in screen size.

Head-up display 100 according to a sixth aspect is head-up display 100 according to any one of the first to fifth aspects, in which angles relative to gut ray 201 of light projected from display component 111 are bilaterally symmetrical or approximately bilaterally symmetrical relative to the second Y-axis.

According to the sixth aspect, as illustrated in FIG. 7, the length of the light path, from image generation device 110 to virtual image region 220, of white light projected from image generation device 110 to form a white-colored virtual image 230 across the entirety of virtual image region 220, can be made approximately uniform in the left-and-right direction, for example. The same can be said for the arrangement of projection optical system 120 in a right-hand drive vehicle and the arrangement of projection optical system 120 in a left-hand drive vehicle.

Furthermore, there is a conventional technique to maintain compatibility with both a projection optical system 120 dedicated for use in a right-hand drive vehicle and a projection optical system 120 dedicated for use in a left-hand drive vehicle, in which the width of light projected from image generation device 110 is increased, and light is projected in excess such that light strays from projected virtual image region 220. In comparison, the present disclosure can contribute to reducing power consumption in image generation device 110 since compatibility is maintained for both types of projection optical systems 120 even when the width of light projected from image generation device 110 is decreased.

Head-up display 100 according to a seventh aspect is head-up display 100 according to any one of the first to sixth aspects, in which image generation device 110 includes at least one lighting lens that is bilaterally symmetrical in shape in a left-and-right direction that corresponds to the left-and-right direction of virtual image 230.

According to the seventh aspect the angles relative to gut ray 201 of light projected from display component 111 can be made to be bilaterally symmetrical in shape relative to the second Y-axis.

While an embodiment has been described herein above, it is to be appreciated that various changes in form and detail may be made without departing from the spirit and scope of the present disclosure as presently or hereafter claimed.

Further Information about Technical Background to this Application

The disclosure of the following patent application including specification, drawings, and claims is incorporated herein by reference in its entirety: Japanese Patent Application No. 2024-049793 filed on Mar. 26, 2024.

### INDUSTRIAL APPLICABILITY

The head-up display according to the present disclosure is suitable for in-vehicle use.

1. A head-up display that projects an image onto an object capable of at least reflecting light, and forms a virtual image that is visible to an observer, in a virtual image region virtually generated on one side of the object relative to the observer, the head-up display comprising:
an image generation device that projects the image; and
a projection optical system that guides the image projected from the image generation device to the object, and forms the virtual image, wherein
the projection optical system includes a first mirror that has power and is closest to the image generation device in order on a light path along which the image generation device projects the image,
when (i) a light beam that passes through a center of the virtual image region is a gut ray, (ii) a point of reflection of the gut ray is a first origin, (iii) a normal line of the first mirror at the first origin is a first Z-axis, (iv) an axis that is orthogonal to the first Z-axis and corresponds to a left-and-right direction of the virtual image is a first X-axis, and (v) an axis that is orthogonal to the first Z-axis and the first X-axis is a first Y-axis, the first mirror is asymmetrical in shape relative to the first Y-axis, and
a length of a first X-axis component of a point A vector and a length of a first X-axis component of a point B vector are identical or approximately identical, the point A vector being a normal vector of a length L1 at a point A that is a predetermined point on the first mirror, the point B vector being a normal vector of the length L1 at a point B that is an other point having a Y-axis value identical to a Y-axis value of the point A and an X-axis value that is an inversely signed number with a magnitude identical to an X-axis value of the point A.

2. The head-up display according to claim 1, wherein
the image generation device includes a display component that displays the image, and
when (i) a point at which the gut ray passes through is a second origin, (ii) a normal line of the display component at the second origin is a second Z-axis, (iii) an axis of the display component that is orthogonal to the second Z-axis and corresponds to the left-and-right direction of the virtual image is a second X-axis, and (iv) an axis that is orthogonal to the second Z-axis and the second X-axis is a second Y-axis, in the display component, a second X-axis component of a gut ray vector is either zero or a minute value, the gut ray vector being located on the gut ray and being of a predetermined length.

3. The head-up display according to claim 1, wherein
when the first X-axis component of the point A vector is AX and the first X-axis component of the point B vector is BX, Expression 1 shown below is satisfied:
$$\vert \vert AX \vert - \vert BX \vert \vert \leq 0.1 \times L 1 \qquad ( Expression 1 )$$

4. The head-up display according to claim 1, wherein
the first mirror is asymmetrical in shape relative to the first X-axis.

5. The head-up display according to claim 1, wherein
in the projection optical system, only the first mirror has power.

6. The head-up display according to claim 2, wherein
angles relative to the gut ray of light projected from the display component are bilaterally symmetrical or approximately bilaterally symmetrical relative to the second Y-axis.

7. The head-up display according to claim 1, wherein
the image generation device includes at least one lighting lens that is bilaterally symmetrical in shape in a left-and-right direction that corresponds to the left-and-right direction of the virtual image.
